(19) United States
(12) Patent Application Publication
(10) Pub. No.: US 2020/0093111 A1
(43) Pub. Date: Mar. 26, 2020

(54) Multi-Purpose, Multi-Rod, Modular Fishing System

(71) Applicant: Michael D. Fryar, Cleveland, TN (US)

(72) Inventor: Michael D. Fryar, Cleveland, TN (US)

(21) Appl. No.: 16/286,565

(22) Filed: Feb. 26, 2019

Related U.S. Application Data
(60) Provisional application No. 62/635,633, filed on Feb. 27, 2018.

(51) Int. Cl. A01K 97/10

(52) U.S. Cl. CPC A01K 97/10; B63B 2035/715; B63B 35/71

(57) ABSTRACT

A maneuverable device for facilitating the optimal use of dual fishing rods on a fishing boat, particularly for use on a kayak, wherein the device may contain one or more compartments for fishing accessories, and the rods may be positioned generally in parallel line with the kayak and may extend forwards and backwards along the plane of the kayak and may also, upon user interest, angle outwards to the right and left of the kayak, respectively.

### CROSS-REFERENCE TO RELATED APPLICATION

This application claims priority to U.S. Provisional Patent Application Ser. No. 62/635,633, titled “Multi-Purpose, Multi-Rod, Modular Fishing System,” filed Feb. 27, 2018, which is fully incorporated herein by reference.

### BACKGROUND OF THE INVENTION

The present invention is directed generally to a fishing system and the rod(s) and tackle involved in such a system. More particularly, the present invention is directed to a novel system for kayak fishing that employs a multi-purpose apparatus functioning as an adjustable, dual rod holder, and centralized tackle containment center, control area, and working platform.

Kayaks are used for several modes of recreation, including both fresh and salt water fishing. An avid sport fisherman may use a fishing-specific kayak made by companies such as Jackson Kayak, Sun Dolphin, Hobie, and Ocean Kayak. Alternatively, a sportsman may use a recreational kayak from the aforementioned companies or others, adapting the cargo and surface areas where necessary to optimize the fishing experience.

In recent years, kayak fishing has emerged in the mainstream of the fishing industry. Though human-use of kayaks as primitive fishing vessels dates back thousands of years, the modern form of kayak fishing began on the shores of California in the 1970s. Fishermen utilized the lightweight watercraft for fishing with increased navigability and ease of use, beginning with Tim Nimeir's design on the Malibu Coast. Kayak fishing has continued to grow and evolve because of its unique ability to provide a controlled approach to fishing out on the water, in addition to its affordability and health benefits. Participation in the sport has increased in recent years, with a reported 38 million kayak fishing trips in the US in 2015 alone. Additionally, according to the 2017 Outdoor Recreation Participation Topline Report, kayak fishing increased by 31.8% from the years 2014-2017, suggesting that more and more fisherman are turning to kayaks for their angling pursuits.

A fishing rod must have some means of securement in a kayak to allow the kayaker to manually drive and navigate. Popular means of attachment include, but are not limited to, deck mount holders, flush mount holders, rail mounted rod holders, and clamps.

Mounted holders, such as those made by the Scotty company, are popular devices that can easily be installed in preferred, secure positions according to the sportsman's preference. Mounted holders may include extension kits or multi-rod configurations, such as the Scotty No. 256 Triple Rod Holder.

More often than not, a kayak outfitted for fishing will include multiple individually mounted rod holders of aforementioned designs or a multi-rod configured holder, separate tackle box, bait plate, navigation device, rod extender, and various accessories. This can result in a cluttered deck or introduce problems into navigability.

A novel system is thus introduced for aggregating rod and accessories in a manner promoting maximum usability. The present invention overcomes the limitations of prior art that do not integrate desirable applications and functions discussed above.

U.S. Pat. No. 5,557,877 to Colson discloses a multi-rod holder with rigid base plate boat mount and rigid rod holder bar mount.

Citing Colson, U.S. 20100299988A1 discloses a multi-saddle extension bar designed to allow for cradling of a fishing rod.

Citing Colson, U.S. Pat. No. 7,849,630 B2 discloses a pistol shaped, mounted holder with hinge and tightening mechanism.

Citing Colson, U.S. 20110154714A1 discloses a stake-based rod holder with footrest and flashlight holder.

These rod holders and fishing systems do not disclose a multi-purpose, fully adjustable, multi-rod holder.

All of these systems are designed for a specific purpose and generally concern fixed rods or arrays of rods. Additionally, none of the systems actually combine nor suggest the combination of a small tackle container and fully extendable control platform.

### BRIEF SUMMARY OF THE INVENTION

In a preferred embodiment, an apparatus is presented that combines multiple rod holders with a bait, tackle and accessory plate, telescopic extender, platform, adjustable rod holders, and asymmetrical compartment.

### DETAILED DESCRIPTION OF THE INVENTION

The unique attributes of the fishing apparatus are presented in detailed embodiments below. Chiefly, the apparatus described in this application is designed to provide any boating sportsman, and particularly a kayaker, the opportunity to position more than one fishing rod in an adjustable holder along with fishing accessories strategically grouped together in a location optimal for multi-tasking, such as fishing from more than one angling posture or location, or manually or electronically navigating the boat.

In an exemplary embodiment, a novel multi-purpose, multi-rod, modular fishing system is presented. The performance and safety benefits of the unique device are evident in the description herein.

The device is an adaptable, portable, multi-purpose double rod holder and extension that can be fitted as an accessory or in a permanent configuration, utilizing an existing single rod holder for support and securement. The device may be of uniform material, e.g. a lightweight polymer designed for water use, or it may contain more than one material, e.g. polymer and one or more metal alloys. The device features a base plate upon which bi-lateral rod holders are mounted on the outer ends, and a central multi-purpose area which holds, if desired, a unique tackle container designed for the device among other options. The bi-lateral rod holders are fixed in position on a forward pivot with the rear sections independently adjustable to allow angling the rod tips outward and away from each other, and fixed locking of position anywhere throughout a specific degree range on the X-axis of movement, as needed. A fixed distance of rod tip separation is achieved through the design and width of the base plate. The rod holders are designed to accommodate fishing rods and reels of a variety of configurations and sizes.

The central tackle container is a design specific storage area featuring a unique tri-fold lid that can permit a variety of open and closed positions producing varying degrees of access to the container while maintaining a low profile and mostly sealed environment. If the central container is not utilized, the multipurpose base plate is pre-drilled to allow for mounting of other optional accessories, devices, and hardware as desired.

The device is able to be fitted to a purpose-built telescopic extension mechanism that connects centrally to the base plate. This telescopic extension mechanism incorporates designs allowing single handed operation for the user to move the device closer to or further away from the user's body thereby facilitating fishing rod and tackle access and control. Additionally, the telescopic extension structure of connection to the base plate is designed for full three-hundred and sixty degrees of rotation in the X-axis and a minimum of positive ninety degrees rotation in the Y-axis and fixed locking of position anywhere within the individual or combination of these ranges for the base plate.

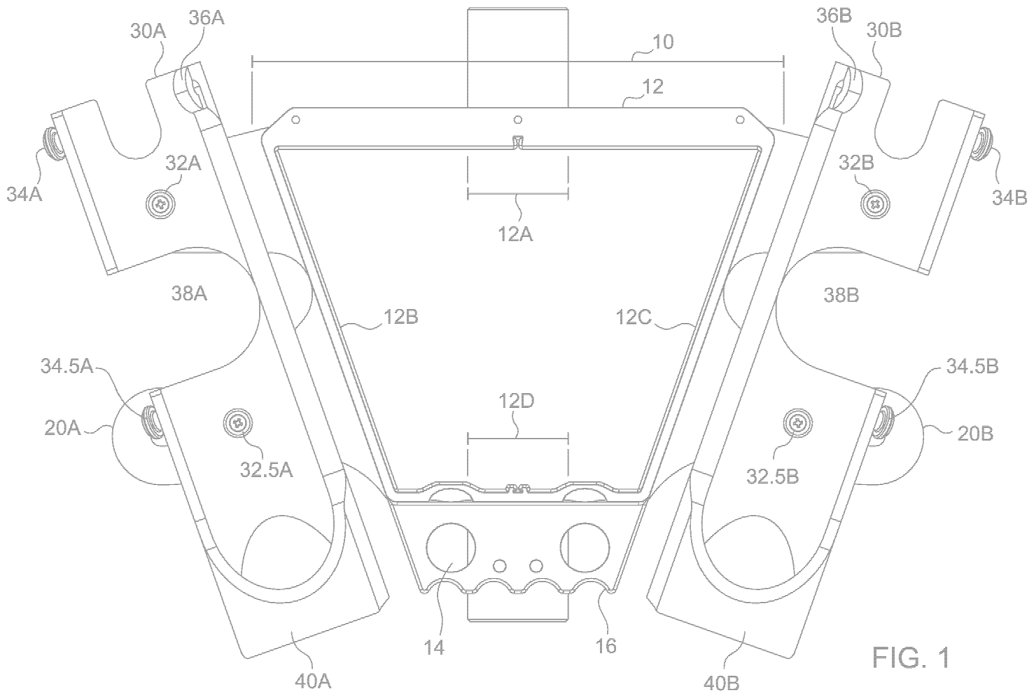

FIG. 1 presents a top plan view of the device.

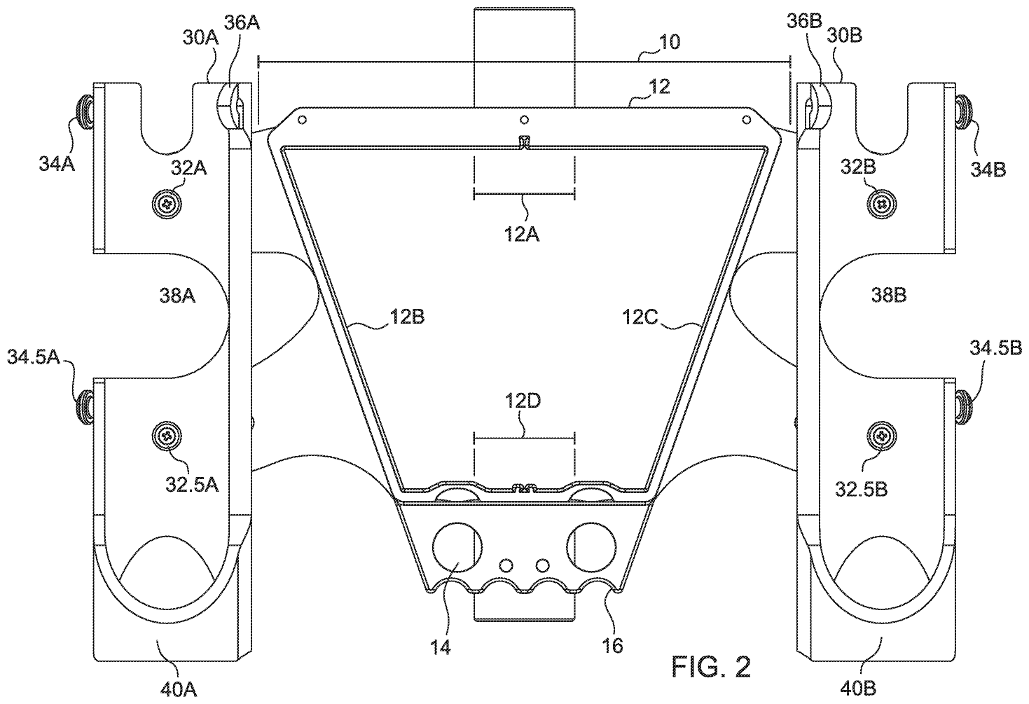

FIG. 2 presents a top plan view as in FIG. 1, but with the adjustable rod holder extended to parallel positions.

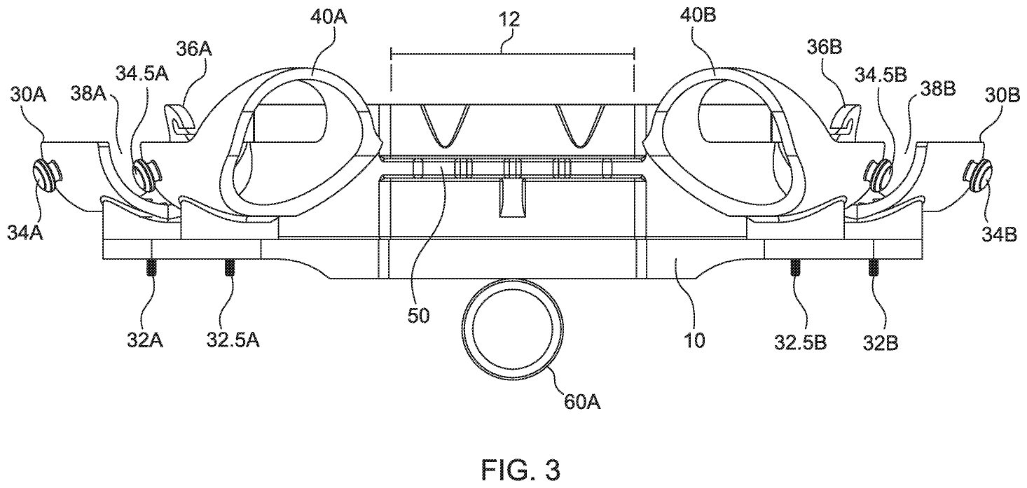

FIG. 3 presents a rear view of the device with rod holders positioned outwards.

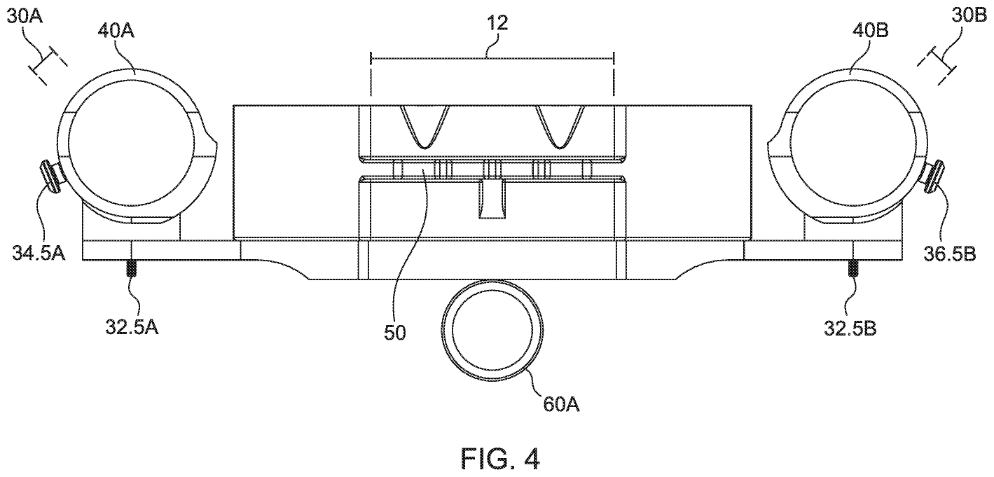

FIG. 4 presents a rear view of the device with rod holders positioned inwards.

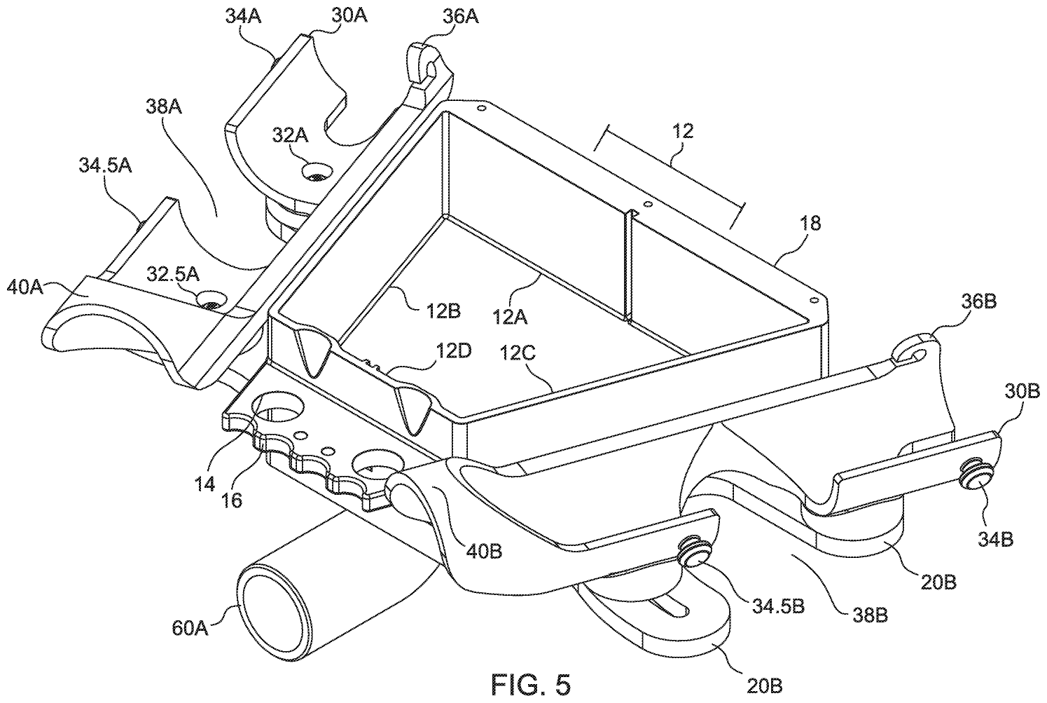

FIG. 5 presents a perspective view of the device.

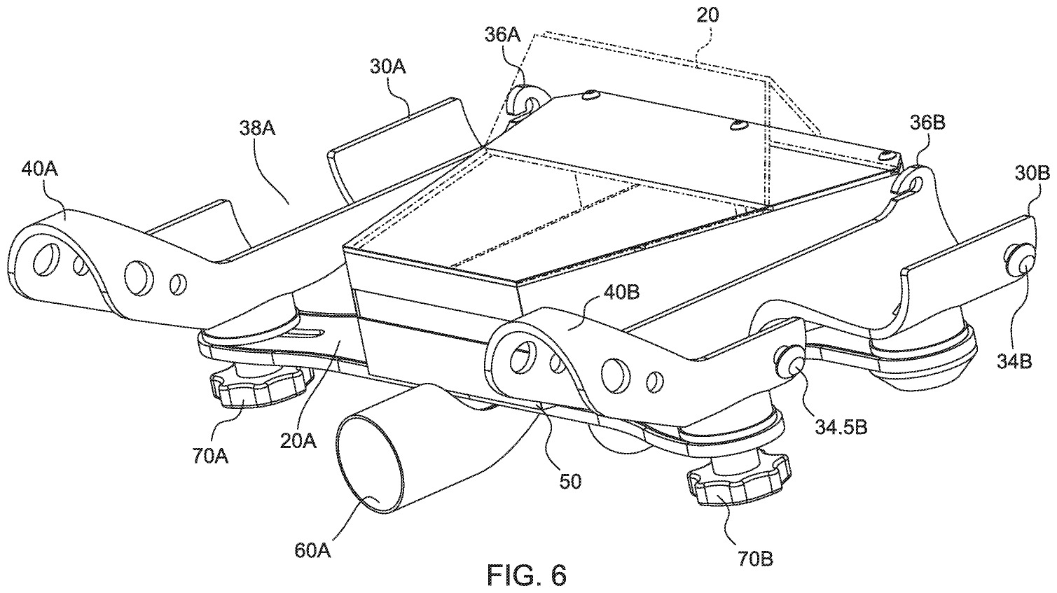

FIG. 6 presents a perspective view highlighting the central container tri-folding lid and the device.

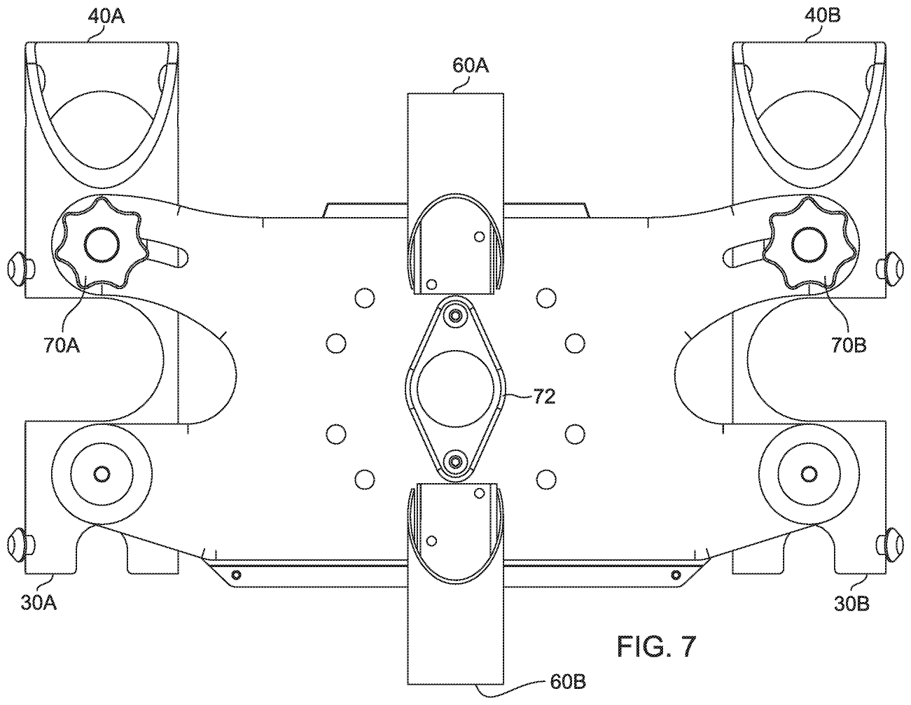

FIG. 7 presents an underside view of the device.

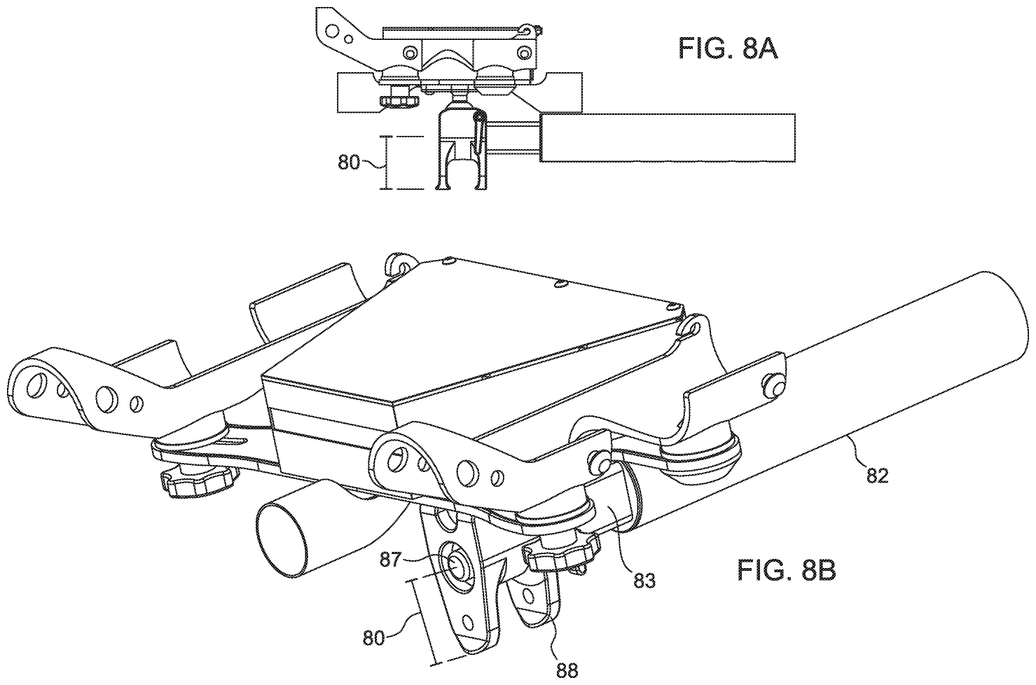

FIG. 8A presents a profile view of the telescopic extender of the device.

FIG. 8B presents a perspective view of the telescopic extender of the device.

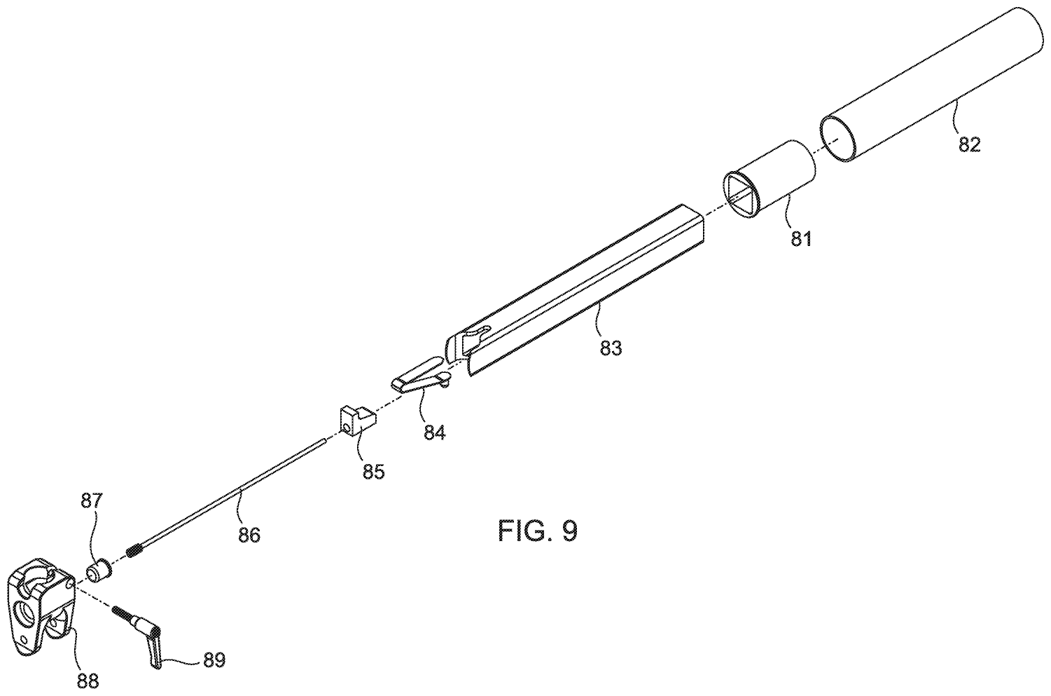

FIG. 9 presents an exploded view of the internal mechanical features of the telescopic extends of the device.

As depicted in FIG. 1, a platform 10 supports a tackle container box 12 of trapezoidal shape featuring a long side 12a distal to the user that narrows from each long side edge 12b, 12c closer to the user where a short side 12d parallel to the long side 12a is extended by a shelf with circular knockouts or holes 14 and a regularly notched edge 16. The shelf allows for placement of angling specific tools such as pliers, hook removers and lures that are important to have readily accessible and organized close to a user's fishing rods and seated position.

FIG. 1 further depicts side extensions or wings 20A, 20B extending from underneath and outwards in both directions to the right and left of the box 12, atop which are positioned rod holders to the left 30A and right 30B of the box 12. The wings 20A, 20B are of one form with the platform 10, and may be constructed of any commonly manufactured and molded plastic or other lightweight material such as aluminum. The rod holders 30A, 30B each feature two points of platform contact 32A, 32.5A, 32B, 32.5B, for example by rod holder and wing penetrating screws securing the rod holders to the platform 10. Each rod holder 30A, 30B further features outer surface anchor points 34A, 34.5A, 34B, 34.5B. These points can serve as a means of attachment by, for example rubber straps, to one or more pivot points 36A, 36B. The material attaching from anchor to pivot points are not limited to rubber, but may include any material that could help to cover or fasten over a fishing rod helping to secure such rod within a rod holder. Each rod holder further features a sectioned -out space 38A, 38B, also referred to as cut-outs or carve-outs, midway between its platform contacts 32A, 32.5A, 32B, 32.5B. These cut-outs allow for the accommodation of rod reels that can turn down into the open spaces when rods are housed within the holders 30A, 30B.

FIG. 2 highlights the repositioning action of the rod holders 30A, 30B, depicting the device as presented in FIG. 1, with the distinction that the rear end portion of said rod holders have been pushed outward away from the platform 10 along the wings 20A, 20B causing the rod holder to be seen as parallel in line with the center axis of the platform 10. When positioned so, fishing rods that would be housed within the holders 30A, 30B would extend straightaways in front of the fisherman user and in parallel line with the user's sporting vessel. When the holders 30A, 30B are positioned as in FIG. 1, with the bottom ends of the rods tucked in towards the bottom and narrower portion of the container box 12, the housed rods would be angled outwards and their fishing lines extending in open waters away from the user's vessel.

FIG. 3 depicts a rear view of the device. The rear side of the device is proximate to the user, with a user accessing left-hand 30A and right-hand 30B holders. Extending from the undercarriage of the platform wings 20A, 20B are attachment points 32A, 32.5A, 32B, 32.5B, represented by screws, that serve as a means of securing the rod holders 30A, 30B to the platform wings 20A, 20B. In this FIG. 3, the, the rod holders 30A, 30B are positioned outwards, such that the housed fishing rods extend to the left and right of the boat or kayak and over the water.

FIG. 4 depicts a rear view of the device with rod holders 30A, 30B in the inward position; that is, each rod holder is parallel to the other extending housed fishing rods in a plane parallel with the boat or kayak. The tackle box 12 may attach removable to the platform 10, for instance by means of Velcro or screws.

FIG. 5 depicts a perspective view of the device. The features of FIG. 1 are reproduced in FIG. 5, with greater depth detail illustrated by the platform 10, and rod holders 30A, 30B.

FIG. 6 depicts yet another perspective view displaying additional features a tri-fold tackle box container lid 20, and tension knobs 70A, 70B. The tension knobs allow for loosing and tightening of the rod holders for inward/outward oscillating action.

FIG. 7 depicts an underside view of the device. Here, tension knobs 70A, 70B allow the user to reach under the device, and by loosening or tightening the tension knobs, to angle the rod holders 30A, 30B inwards and outwards proximate to the user's body. Such manipulation results in a fishing rod extending parallel and in line with the boat or kayak surface, or projecting outwards away from the boat or kayak in a range of degrees. As a tension knob is loosened, a rod in the respective rod holder can be easily manipulated, and once angled to the desired degree, the tension knob can be tightened to secure the rod and rod holder in place against water current or drag, or a pull upon a fishing line. Tubular sleeves 60A, 60B pointing oppositely north and south underneath the device serve as rigid attachment points for third party rod mounts, and when not in use they can be stuffed with foam or other material to provide bouyancy if for some reason the device becomes detached and is in danger of being submerged within a body of water. A bushing acting as external sleeve, not pictured, envelopes the tubular sleeves 60A, 60B and permits a variety of third-party rod holder mounts to be utilized within a mounting system (e.g. Scotty, Yak Gear, etc.), also not pictured. An attachment 72 further allows for the optional attachment of a telescopic extension pole.

FIGS. 8A and 8B are side and perspective views of the device emphasizing the push-button telescopic extender 80 as attached to the underside attachment 72. In these figures the telescopic extender is in the collapsed, or not extended position. Pushing and holding the button 87, would allow the user to pull the extender bracket 88 towards the user, thus positioning the entire system closer to the user for maximum manipulation. This may occur in the event that a fishing line has been engaged and the user notices tension upon the line suggesting a fish bite.

FIG. 9 depicts an exploded view of a telescopic extender system. The telescopic system is uniquely designed to serve as a secure connection and pivot point for the platform while simultaneously acting as an extension device that allows single handed operation in allowing the angler to quickly bring the entire platform towards or away from the angler's body. The telescopic system uniquely utilizes existing rod holder support structures to retain and secure it. In this way the telescopic system does not require any permanent modification(s) to the boat, or removal of an existing rod holder or its components. The telescopic system features common components inner 81 and outer 82 tubular members, telescopic tube square 83, locking tube pin 84, tab 85, extender pin 86, button cap 87, housing 88, and locking handle 89.

I claim:

1) An apparatus for fishing upon a vessel from a waterborne position, comprising:
a vessel surface mount;
a horizontal extension from said mount extending towards the vessel operator;
a platform atop said horizontal extension distal from the surface mount and proximate to the vessel operator; and,
two fishing rod holders positioned opposite one another and attached to said platform.

2) The apparatus of claim 1, wherein the vessel is a kayak.

3) The apparatus of claim 1, wherein each fishing rod holder attachment consists of one underside platform anchor and one pivoting or sliding underside tension knob beneath the platform.

4) The apparatus of claim 1, wherein the horizontal extension is a telescopic extension rod with push-button release.

5) An apparatus for using multiple fishing rods simultaneously upon a kayak, comprising:
a telescopic extension pole with an attachment point distal to the user attaching to a kayak mount and a control mechanism proximate to the user allowing the user to extend the pole towards and away from his body lengthwise along the plane of the kayak;
a platform positioned atop the proximate end of the telescopic extension pole; and,
on each side of the platform an adjustable fishing rod holder.

6) The apparatus of claim 5 wherein the control mechanism of the telescopic extension is a push-button release for single-handed use.

7) The apparatus of claim 5 wherein attached to the platform on its top side is a removable, V-shaped container.

8) The apparatus of claim 5 wherein each fishing rod holder is fixed at its end distal to the user and may flex inwards towards the platform at its end proximate to the user causing the fishing rod to extent its line outwards and away from the kayak.

9) The apparatus of claim 5 wherein each fishing rod holder is rigidly fixed to the platform at the holder's distal end and is adjustably fixed to the platform at the holder's proximate end by a tension knob.

10) The apparatus of claim 5 wherein the platform has two sets of bilateral arms extending in opposite directions perpendicular to the lengthwise orientation of the kayak.

11) A system for kayak fishing using at least two fishing rods simultaneously while navigating a kayak consisting of:
a mounted holder fixed to the surface of a kayak and extending up vertically from the plane of the kayak;
a tubular telescopic extension pole with push button release extendable back and forth along the plane of the kayak;
a platform atop the extension pole with four bilateral wings extending to the left and right of the supporting extension pole;
a trapezoidal container box fixed atop the platform with the narrowest part proximate to the kayak operator; and,
a left and right fishing rod holder positioned each to one side of the container box, fixedly attached to the platform wings distal to the kayaker and slidably attached to the platform wings proximate to the kayaker.

12) The system of claim 11, where the fishing rod holders are slidably attached by tension knobs on the underside of the platform wings.

13) The system of claim 11, where the rod holders have midpoint carveouts between the platform wing attachment points.
